(19) United States
(12) Patent Application Publication
(10) Pub. No.: US 2019/0002210 A1
(43) Pub. Date: Jan. 3, 2019

(54) CONVEYOR SPACER GUARD

(71) Applicant: Dematic Corp., Grand Rapids, MI (US)

(72) Inventors: Benjamin J. Hekman, Holland, MI (US); Jeffrey D. Price, Grand Rapids, MI (US); David L. Spaulding, Ada, MI (US); Harry T. German, Belding, MI (US)

(21) Appl. No.: 16/022,043

(22) Filed: Jun. 28, 2018

Related U.S. Application Data
(60) Provisional application No. 62/527,639, filed on Jun. 30, 2017.

(51) Int. Cl. B65G 47/66

(52) U.S. Cl. CPC B65G 47/66; B65G 2812/02019

(57) ABSTRACT

A guard for a conveyor assembly, with the conveyor assembly having a pair of spaced apart side frames and at least a pair of adjacent conveyor zones, with each conveyor zone comprising a pair of rollers about which a conveyor belt is disposed with the rollers of the zones mounted between the side frames and a gap formed between the conveyor zones. The guard has an elongate lower portion configured to mount between the side frames in the gap, with the lower portion having a mounting receptacle configured to receive a connector for mounting the guard between the side frames. The guard also includes at least one elongate outwardly angled side extending upwards from the lower portion to a top surface, with the angled side configured to be disposed adjacent one of the rollers of one of the conveyor zones.

### CROSS REFERENCE TO RELATED APPLICATION

The present application claims priority of U.S. provisional application Ser. No. 62/527,639 filed Jun. 30, 2017, which is hereby incorporated herein by reference in its entirety.

### BACKGROUND OF THE INVENTION

The present invention is directed to a guard used with conveyors, and in particular to a guard disposed between adjacent segments of belt conveyors.

Conveyors are known to be constructed with multiple adjacent belted conveyor segments or zones, with the belts disposed about rollers. A space or gap is formed between the rollers of adjacent belted conveyor segments.

### SUMMARY OF THE INVENTION

The present invention provides a guard for a conveyor configured to be disposed between adjacent conveyor zones of a conveyor assembly.

According to an aspect of the present invention, the guard includes an elongate lower portion configured to mount between side frames of a conveyor, with the lower portion having a pair of mounting receptacles at either end configured to receive connectors for mounting the guard between the side frames of the conveyor, such as to be disposed in a gap between adjacent belted conveyor zones. A pair of elongate outwardly angled sides extend upwards from the lower portion to a top surface, with each of the angled sides configured to be disposed proximate separate rollers of the conveyor, such as proximate adjacent rollers from two adjacent belted conveyor segments.

In particular embodiments the outwardly angled sides are unitarily formed with the lower portion, and an internal cavity is formed by the top surface and the outwardly angled sides. The top surface may further include angled chamfer portions adjacent the outwardly angled sides. Still further, the lower portion may include a pair of downwardly extending legs, with each leg including a mounting receptacle comprising a channel configured to receive a leg of the connector.

A conveyor assembly in accordance with aspects of the invention includes adjacent belted conveyor zones with a guard mounted in a gap formed between the adjacent belted conveyor zones. The conveyor assembly includes a pair of spaced apart side frames between which the conveyor zones are mounted, with each conveyor zone comprising a pair of rollers about which a conveyor belt is disposed and with the rollers mounted between the side frames. The guard includes an elongate lower portion configured to mount between the side frames in the gap, with the lower portion having a pair of mounting receptacles at either end configured to receive connectors for mounting the guard to the side frames. In a particular embodiment the guard comprises a pair of elongate outwardly angled sides extending upwards from the lower portion to a top surface, with each of the angled sides configured to be disposed proximate adjacent rollers from the two adjacent belted conveyor segments.

The guards of the present invention are easily installed and both inhibit fingers of operators from being inadvertently inserted between rollers of a conveyor assembly, as well as promote the flow of objects or items along the conveyor assembly, including smaller sized cartons that might otherwise become disoriented in the gap between conveyor zones.

These and other objects, advantages, purposes and features of this invention will become apparent upon review of the following specification in conjunction with the drawings.

### BRIEF DESCRIPTION OF THE DRAWINGS

FIG. 1 is an overhead perspective view of a belted conveyor assembly comprising two segments or zones that include conveyor spacer guards in accordance with the present invention;

FIG. 2 is a top plan view of the conveyor assembly of FIG. 1 shown with the conveyor belts removed for clarity;

FIG. 3 is a partial side elevation view of a portion of the conveyor assembly of FIG. 1;

FIG. 4 is a partial side sectional elevation view of a portion of the conveyor assembly of FIG. 1 taken along the line IV-IV of FIG. 2;

FIG. 5 is a top perspective view of the conveyor spacer guard in accordance with the present invention shown removed from the conveyor assembly of FIG. 1;

FIG. 6 is a top plan view of the conveyor spacer guard of FIG. 5;

FIG. 7 is a side elevation view of the conveyor spacer guard of FIG. 5;

FIG. 8 is an end elevation view of the conveyor spacer guard of FIG. 5;

FIGS. 9A-9C are a top plan view, side elevation view and end view of a clip configured to retain the conveyor spacer guard of FIG. 5 to the side frames of the conveyor assembly of FIG. 1;

FIG. 10 is a top perspective view of an alternative conveyor spacer guard in accordance with another aspect of the present invention;

FIG. 11 is a top plan view of the conveyor spacer guard of FIG. 10;

FIG. 12 is a side elevation view of the conveyor spacer guard of FIG. 10;

FIG. 13 is an end elevation view of the conveyor spacer guard of FIG. 10; and

FIG. 14 is a top perspective view of an upper portion of the conveyor spacer guard of FIG. 10.

### DESCRIPTION OF THE PREFERRED EMBODIMENTS

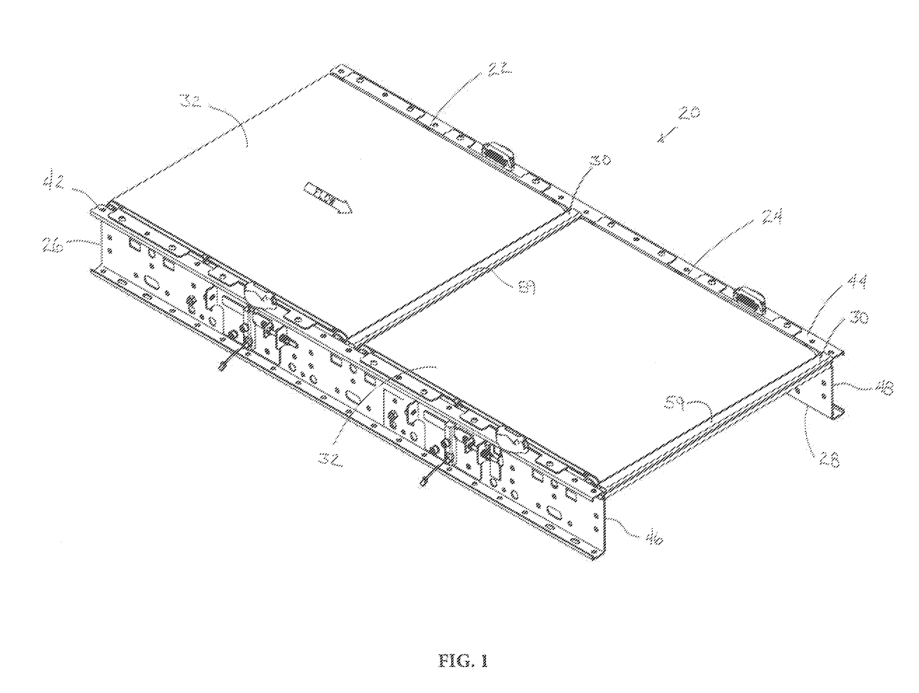

The present invention will now be described with reference to the accompanying figures, wherein the numbered elements in the following written description correspond to like-numbered elements in the figures. A conveyor assembly or conveyor section 20 including two belted conveyor zones or segments 22, 24 disposed between side frames 26, 28 is illustrated in FIG. 1, where spacer guards 30 are disposed between adjacent conveyor zones, such as between zones 22, 24. Guards 30 are configured to substantially span the gap between the adjacent conveyor zones to thereby inhibit the fingers of operators from inadvertently extending there between, whereby guards 30 provide a safety feature. Guards 30 additionally promote the conveyance of items, such as cartons, along conveyor 20 by inhibiting the cartons from being inadvertently disrupted by the gap between the adjacent conveyor zones, such as may occur in particular with smaller sized or irregular shaped cartons.

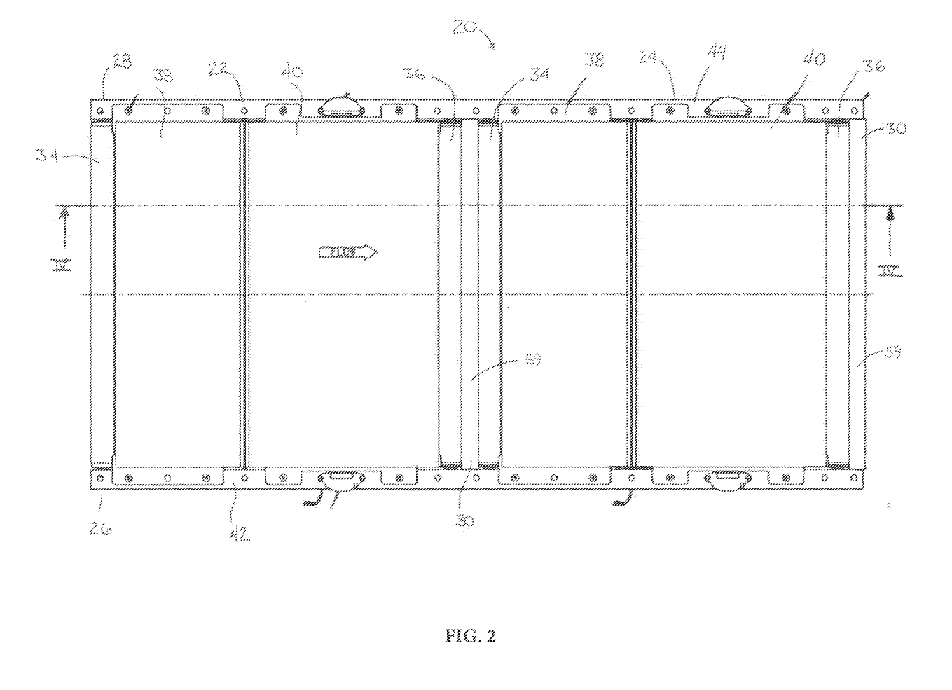

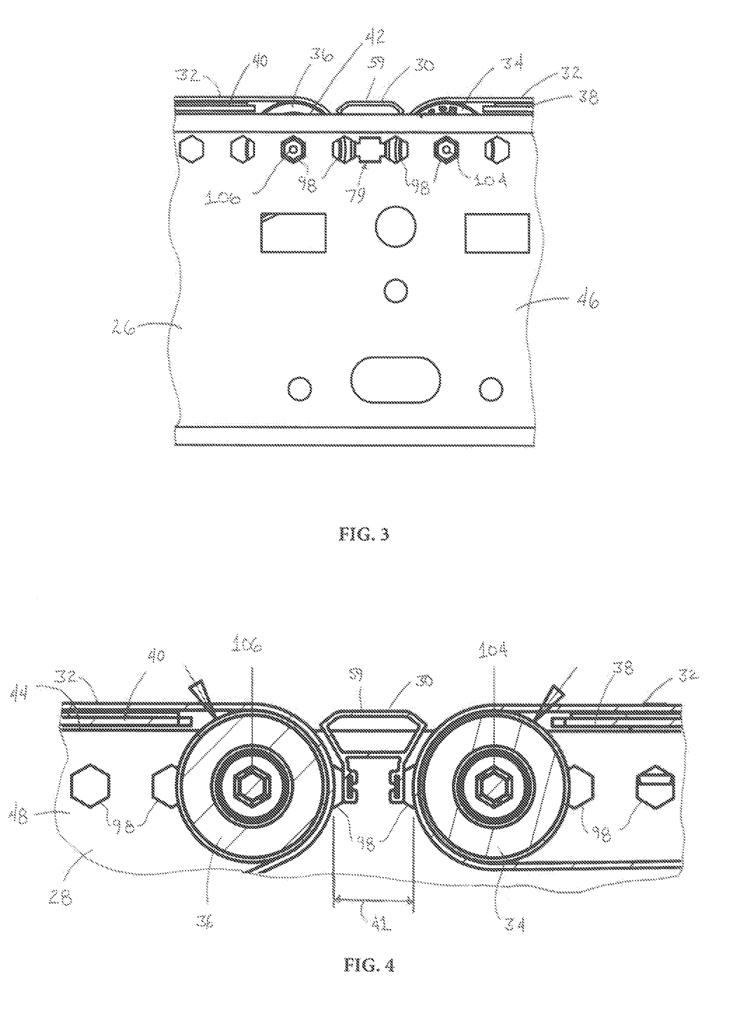

As illustrated in FIGS. 1 to 4, conveyor zones 22, 24 each include a conveyor belt 32 disposed about upper rollers 34, 36, with belt 32 sliding over slider pan assemblies 38, 40. As understood from FIGS. 2 and 4, the roller 36 of zone 22 is spaced from the roller 34 of zone 24 to thereby form a space or gap 41 within and between which guard 30 is disposed. Slider pan assemblies 38, 40 are mounted to horizontally oriented, outwardly extending upper surfaces or flanges 42, 44 of side frames 26, 28, with rollers 34, 36 being mounted to and between upright portions 46, 48 of side frames 26, 28. As understood from FIGS. 3 and 4, rollers 34, 36 are mounted whereby a portion of each of rollers 34, 36 extends vertically above the level of flanges 42, 44, with the belts 32 disposed about rollers 34, 36 thus likewise being located vertically above the level of flanges 42, 44 to slide over the upper surface of slider pan assemblies 38, 40. As discussed in more detail below, guard 30 is likewise mounted to and between upright portions 46, 48 of side frames 26, 28, with a portion of guard 30 also extending vertically above the level of flanges 42, 44.

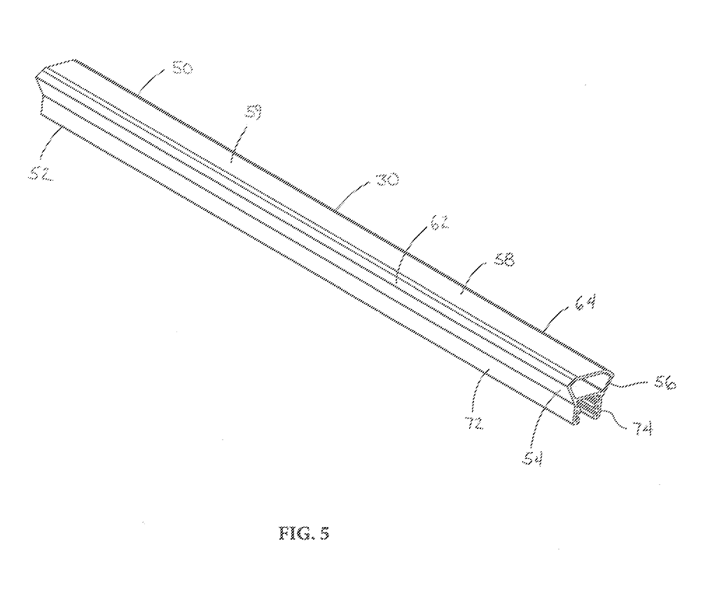

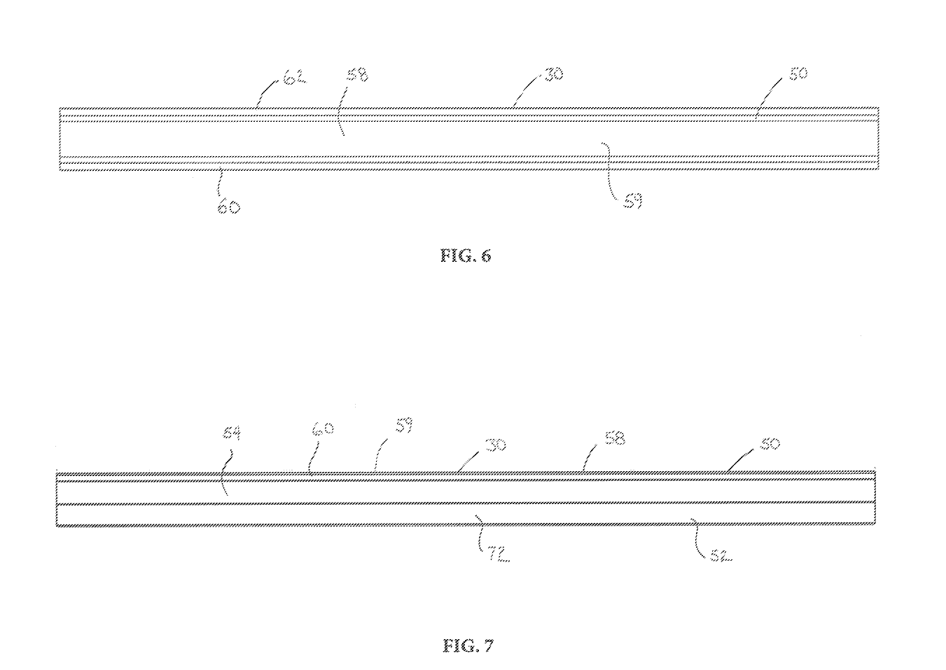

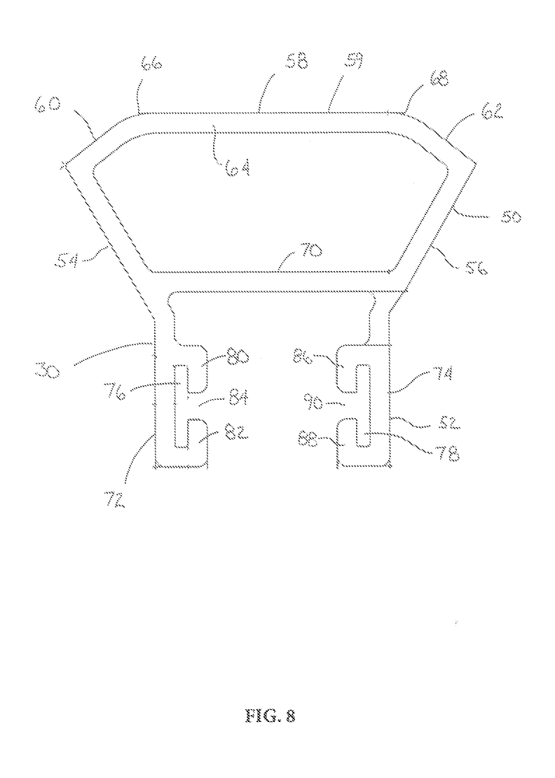

Referring now to the embodiment of FIGS. 5 to 8, guard 30 is shown to have a unitary, elongate configuration, where in the illustrated embodiment, guard 30 is constructed as an extruded metallic member, such as an aluminum extrusion. Guard 30 may, however, be constructed of alternative materials and processes, such as plastic. The unitary elongate construction facilitates the manufacturing and assembly of guard 30.

Guard 30 includes an upper portion 50 and a lower portion 52, with lower portion 52 used to mount guard 30 between frames 26, 28, as discussed in more detail below. Upper portion 50 includes a pair of upwardly and outwardly angled members or sides 54, 56 extending from lower portion 52, with a top member or side 58 spanning between angled members 54, 56, where top member 58 defines an upper surface of guard 30. Top member 58 additionally includes chamfer portions 60, 62 that are downwardly angled from a horizontal portion 64 to the angled members 54, 56, where in the illustrated embodiment the transition from the horizontal portion 64 to each of the chamfer portions is curved or radiused at 66, 68 to thereby provide a smooth transition for items traversing top member 58. In an alternative embodiment, however, a guard may be configured without chamfer portions 60, 62 whereby top member 58 would define a top surface that is generally horizontal and flat between angled members 54, 56. A connector member 70 extends between angled members 54, 56 at the transition between upper portion 50 and lower portion 52, upper portion 50 thus defining a generally trapezoid or trapezoidal shape in cross section, and with angled members 54, 56, top member 58 and connector member 70 defining an internal cavity.

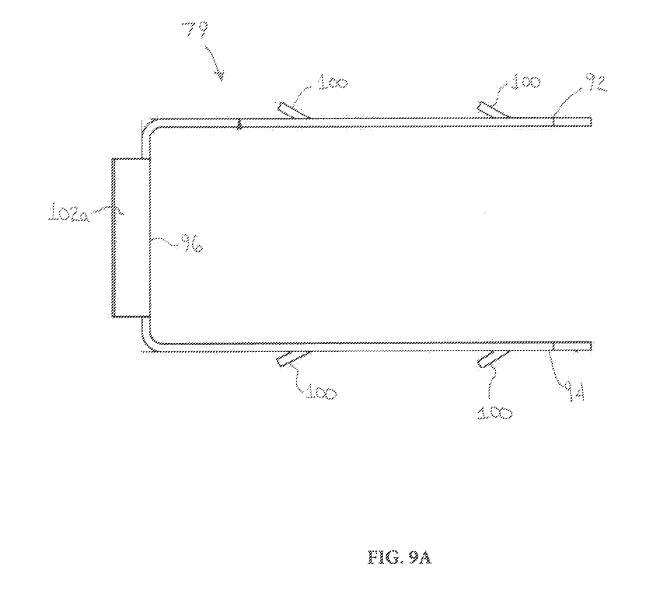

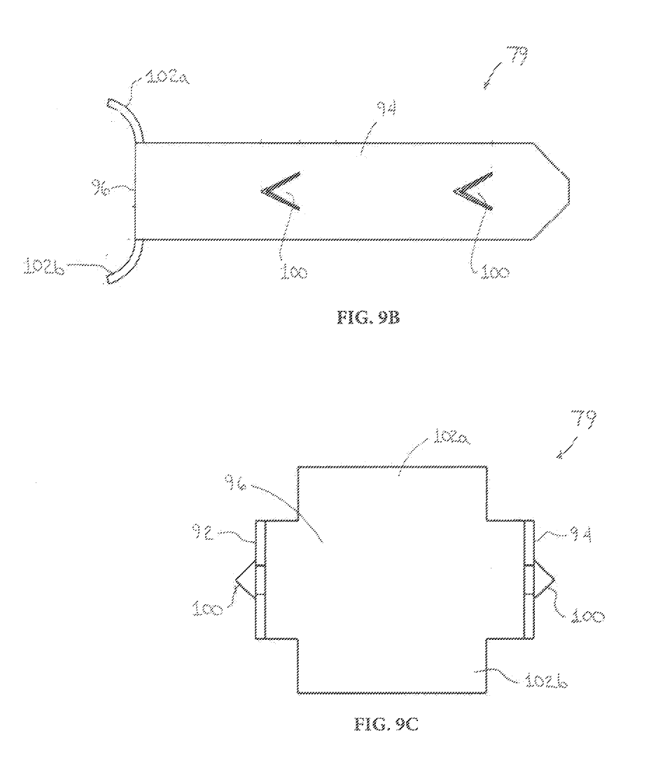

Lower portion 52 is disposed beneath upper portion 50 and, as noted, is constructed unitarily with upper portion 50 in the embodiment of FIGS. 5 to 8. As shown, lower portion 52 includes a pair of downwardly extending legs or leg members 72, 74. Each leg 72, 74 includes receptacles, which in the illustrated embodiment comprise channels 76, 78 for receiving a connector 79, as shown in FIGS. 9A-9C and discussed in detail below, to mount the guard 30 between side frames 26, 28. In the illustrated embodiment channels 76, 78 extend the entire elongate length of lower portion 52 whereby each end of the guard 30 is provided with receptacles. Channel 76 is formed by a pair of inwardly oriented L-shaped protrusions 80, 82 that are separated by a gap 84. Likewise, channel 78 is formed by a pair of inwardly oriented L-shaped protrusions 86, 88 that are separated by a gap 90. It should be appreciated that alternative receptacles and/or methods of connecting or mounting guards between side frames 26, 28 may be employed within the scope of the present invention. Still further, although lower portion 52 has a generally C-shaped or U-shaped configuration defined by connector member 70, legs 72, 74 and the opening there between, it should be appreciated that alternative configurations may likewise be employed.

Referring now to FIGS. 9A to 9C, connector 79 is used to mount guard 30 to and between side frames 26, 28. Connector 79 comprises a C-shaped or U-shaped device having a pair of legs 92, 94 separated by a base member 96, with legs 92, 94 configured for insertion into channels 76, 78 of guard 30. In particular, as understood from FIG. 3, side frames 26, 28 each include a plurality of spaced mounting apertures 98, with legs 92, 94 being extended into channels 76, 78 through a pair of adjacent mounting apertures 98. Each leg 92, 94 includes a pair of extending projections or protrusions 100 that contact and engage with legs 72, 74 of guard 30 for securely retaining connector 79 within lower portion 52 of guard 30, where protrusions 100 engage with legs 72, 74 internally within channels 76, 78. As noted, legs 92, 94 are separated by a base member 96 that is used for grasping connector 79 for insertion and removal from guard 30 through apertures 98. To this end, base member 96 additionally includes upper and lower outwardly extending tabs 102a, 102b for aiding in the grasping of connector 79. As also understood from FIG. 3, apertures 98 are additionally used in the mounting of rollers 34, 36 to side frames 26, 28, where axles 104, 106 of rollers 34, 36 are mounted within apertures 98. Thus, via the engagement of connector 79 with lower portion 52 of guard 30, the lower portion 52 is generally horizontally aligned with the axis of rotation of rollers 34, 36.

With further reference to FIG. 4, top member 58 is illustrated as being disposed between rollers 34, 36 such that the upper surface 59 is disposed slightly beneath the primary conveying surface plane of belts 30 of conveyor zones 22, 24, such as approximately two millimeters in the illustrated embodiment. This provides a waterfall effect to the objects being conveyed along conveyor 20 between zones 22, 24. Moreover, angled members 54, 56 extend upward along the circumferential profile of rollers 34, 36 to fill the gap 41 as the gap 41 opens up as a result of the circular profile of the rollers 34, 36. Guard 30 thus inhibits items being conveyed on conveyor 20 from getting caught within or disrupted by gap 41 to thereby optimize the product handling along conveyor 20, and with chamfer portions 60, 62 further aiding in the transitioning of the items being conveyed from conveyor zone 22 to conveyor zone 24. In the illustrated embodiment, the distance between the belts 30 of conveyor zones 22, 24 relative to the guard 30 is less than four millimeters, such as between belt 30 of zone 22 relative to the intersection of chamfer portion 60 and angled member 54 and between belt 30 of zone 24 relative to the intersection of chamfer portion 62 and angled member 56.

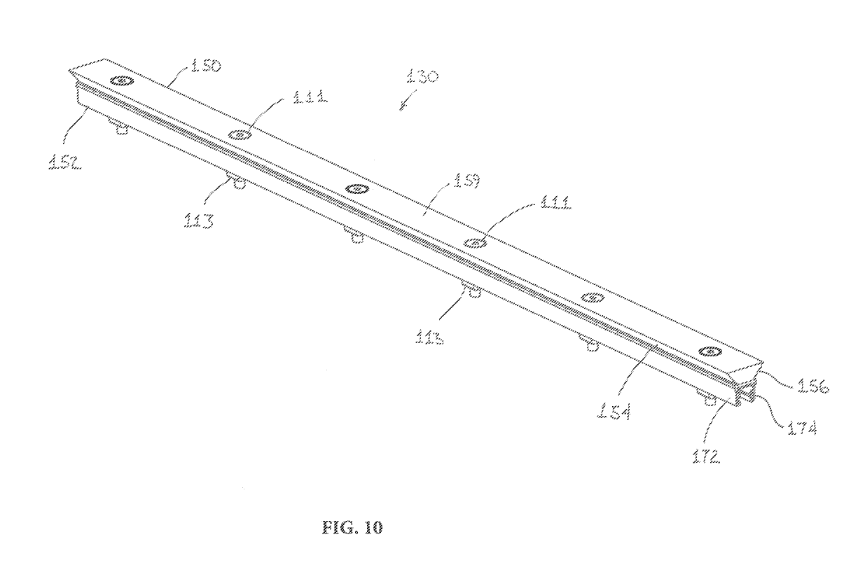

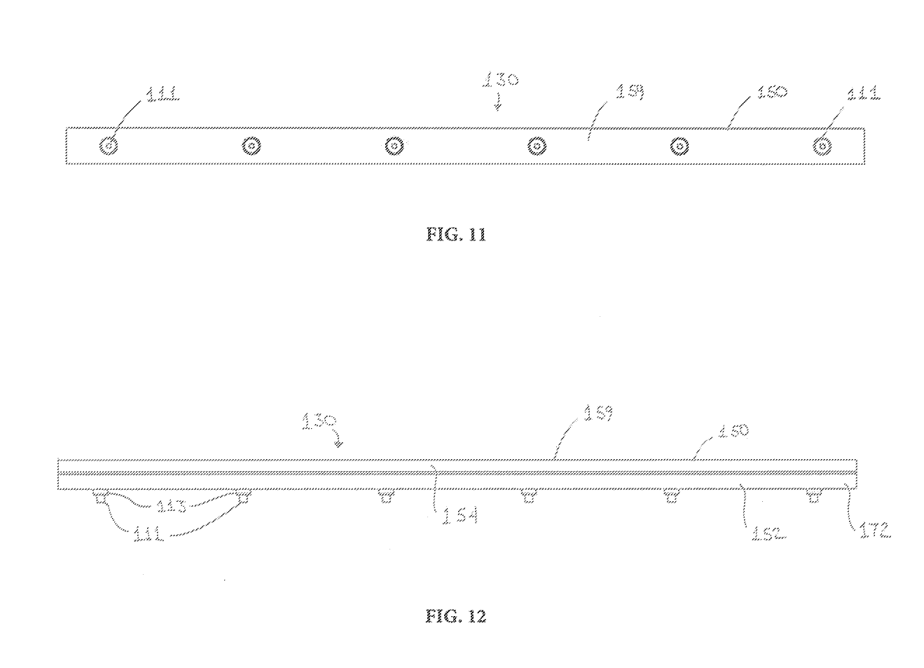

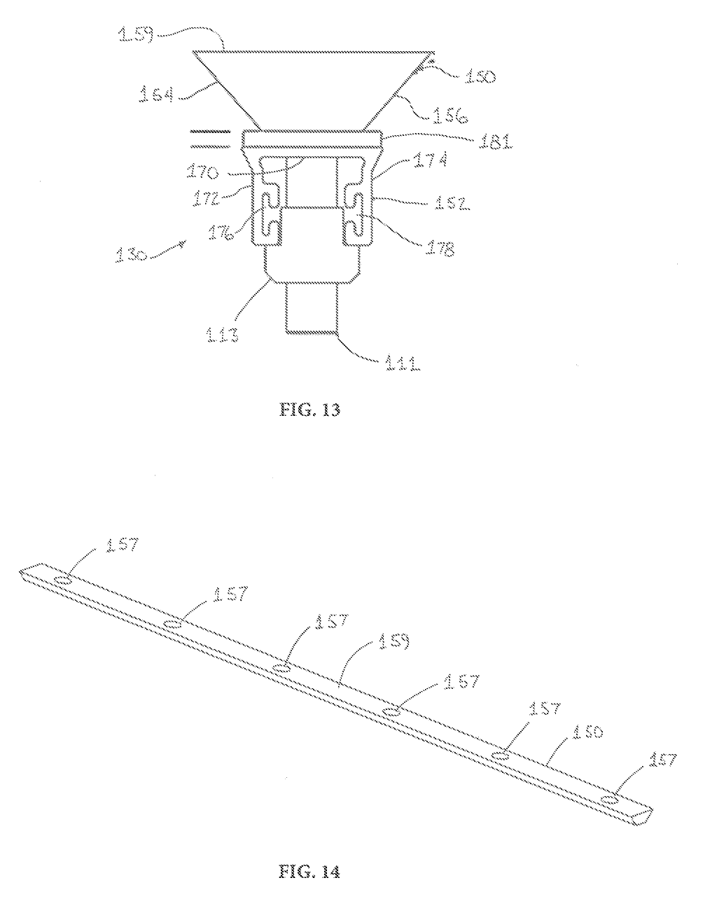

Referring now to FIGS. 10-14, an alternative guard 130 is disclosed that shares features of guard 30, with similar features of guard 130 being designated with similar reference numbers relative to guard 30, but with “100” added to the reference numbers of guard 30.

Guard 130 includes an upper portion 150 and a separately formed lower portion 152, with portions 150 and 152 being secured together via fasteners, such as via threaded screws 111 and nuts 113, where nuts 113 comprise T-slotted nuts. In the embodiment of FIGS. 10-14, upper portion 150 comprises a plastic material, such as an ultra-high-molecular-weight (“UHMW”) polymeric material, which may be a polyethylene polymeric material, and may alternatively be referred to as high-modulus polyethylene (HMPE) or high-performance polyethylene (HPPE). Upper portion 150 has a generally trapezoid or trapezoidal cross sectional profile with a top side or surface 159 and angled portions or sides 154, 156, as well as multiple chamfered through holes 157 for receiving screws 111.

Lower portion 152 comprises a pair of downwardly extending legs 172, 174, each of which includes a receptacle configured as a channel 176, 178 for receiving a connector, such as connector 79 discussed above. Legs 172, 174 are joined by a connector member 170, whereby lower portion 152 has a generally C-shaped or U-shaped cross sectional profile. Lower portion 152 is likewise formed as an elongate member that extends between upright portions 46, 48 of side frames 26, 28, and may be formed by an extruded metallic or plastic material.

Guard 130 further employs a shim 181 disposed between upper portion 150 and lower portion 152, where the thickness of shim 181 may be selected to adjust the relative orientation between upper portion 150 and lower portion 152, including to adjust the vertical height of top surface 159 relative to channels 176, 178. Accordingly, the vertical orientation of upper surface 159 may be adjusted relative to the primary conveying surface, such as of the belts 30 sliding over slider pan assemblies 38, 40. In the illustrated embodiment shim 181 is configured as an elongate member extending generally the entire length of upper portion 150.

It should be appreciated that guard 30 may be constructed to have different profiles and/or different vertically oriented heights extending relative to flanges 42, 44, as well as different widths based on a particular conveyor configuration. Other changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A guard for a conveyor, said guard comprising:
an elongate lower portion configured to mount between side frames of a conveyor, said lower portion having a mounting receptacle configured to receive a connector for mounting said guard between the side frames of the conveyor; and
an elongate outwardly angled side extending upwards from said lower portion to a top surface, said angled side configured to be disposed adjacent a roller of the conveyor.

2. The guard of claim 1, wherein said guard includes a second outwardly angled side extending upwards from said lower portion to said top surface, and wherein said second outwardly angled side is configured to be disposed adjacent another roller of the conveyor.

3. The guard of claim 2, wherein said outwardly angled sides are unitarily formed with said lower portion.

4. The guard of claim 3, wherein an internal cavity is formed by said top surface and said outwardly angled sides.

5. The guard of claim 4, wherein said top surface includes an angled chamfer portion adjacent one of said outwardly angled sides.

6. The guard of claim 5, wherein said top surface includes a pair of angled chamfer portions, wherein one said angled chamfer portion is adjacent each of said outwardly angled sides.

7. The guard of claim 2, further including an internal connector member disposed vertically above said receptacle member and extending between said outwardly angled sides.

8. The guard of claim 2, wherein said mounting receptacle comprises a channel.

9. The guard of claim 2, wherein said lower portion includes a pair of mounting receptacles.

10. The guard of claim 9, wherein both said mounting receptacles comprise channels.

11. The guard of claim 2, wherein said lower portion includes a pair of legs, wherein each said leg includes a mounting receptacle and wherein said legs are downwardly extending relative to said angled sides.

12. The guard of claim 11, wherein each said mounting receptacle comprises a channel.

13. The guard of claim 12, wherein each said leg extends downwardly from a respective one of said angled sides.

14. The guard of claim 2, wherein said lower portion includes a pair of mounting receptacles with said lower portion having a pair of opposed ends, wherein one said mounting receptacle is located at each of said ends.

15. A conveyor assembly, said conveyor assembly comprising:
a pair of spaced apart side frames;
a pair of adjacent conveyor zones, each said conveyor zone comprising a pair of rollers about which a conveyor belt is disposed with said rollers of said zones mounted between said side frames, wherein a gap is formed between said conveyor zones;
a guard, said guard comprising an elongate lower portion configured to mount between said side frames in said gap, with said lower portion having a mounting receptacle configured to receive a connector for mounting said guard between said side frames, said guard further comprising an elongate outwardly angled side extending upwards from said lower portion to a top surface, said angled side configured to be disposed adjacent one of said rollers of one of said conveyor zones.

16. The conveyor assembly of claim 15, wherein said guard includes a second outwardly angled side extending upwards from said lower portion to said top surface, and wherein said second outwardly angled side is configured to be disposed adjacent one of said rollers of the other said conveyor zone.

17. The conveyor assembly of claim 16, wherein said outwardly angled sides are unitarily formed with said lower portion.

18. The conveyor assembly of claim 16, wherein said lower portion includes a pair of mounting receptacles with said lower portion having a pair of opposed ends, wherein one said mounting receptacle is located at each of said ends.

19. The conveyor assembly of claim 18, wherein said mounting receptacles comprise channels, and wherein said guard is mounted between said side frames via a pair of connectors.

20. The conveyor assembly of claim 18, wherein said side frames include a plurality of apertures, and wherein each said connector is extended through at least one said aperture into said receptacle.
